(19) United States
(12) Patent Application Publication
(10) Pub. No.: US 2008/0023458 A1
(43) Pub. Date: Jan. 31, 2008

(54) SHEET BORING APPARATUS AND IMAGE FORMING APPARATUS

(75) Inventor: Koki Watanabe, Moriya-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/781,800

(22) Filed: Jul. 23, 2007

(30) Foreign Application Priority Data
Jul. 28, 2006 (JP) 2006-205815

(51) Int. Cl. B23K 26/38; B65H 67/00

(52) U.S. Cl. 219/200; 101/26

(57) ABSTRACT

A sheet boring apparatus is configured to bore a hole in a sheet bundle by processing a portion of the sheet bundle along and inside an outline of the hole to form a remaining portion and by dropping the remaining portion. The sheet boring apparatus includes a laser processing unit configured to emit a laser beam on to the sheet bundle to perform boring processing, and a moving portion configured to move an emitting process position of the laser beam. When the laser processing unit performs boring processing, the moving portion moves the emitting process position of the laser beam in a direction of thickness of the sheet bundle and a direction of processing width inside the outline of the hole to narrow the processing width toward a bottom of the sheet bundle.

### BACKGROUND OF THE INVENTION

1. Field of the Invention

The present invention relates to a sheet boring apparatus configured to bore a hole in a sheet bundle with a laser beam, and also relates to an image forming apparatus that includes the sheet boring apparatus.

2. Description of the Related Art

Conventional sheet boring apparatuses configured to bore holes are discussed in Japanese Patent Application Laid-Open No. 9-99383 and U.S. Pat. No. 5,797,320. These sheet boring apparatuses are configured to bore a hole in each sheet.

A conventional sheet boring apparatus can bore a hole H in a sheet bundle Pa, as illustrated in FIG. 8. The conventional sheet boring apparatus processes a portion PD of the sheet bundle Pa along the inner side of the hole H into a cylindrical shape with a laser beam LB, and drops a remaining portion PR left as scrap after the boring process to form the hole H in the sheet bundle Pa.

However, because of a uniform width W of the portion PD processed into a cylindrical shape, the remaining portion PR may tilt in the middle of dropping to get stuck in the hole H, thus being left in the hole H. The laser beam LB is applied through the sheet bundle Pa to bore a hole in the sheet bundle Pa. As a penetrated portion of the sheet bundle Pa with the laser beam LB is wider, supporting the remaining portion PR while maintaining a posture thereof is more difficult, thus causing tilting of the remaining portion PR. In this case, sheets constituting the remaining portion PR stick to one another to collect the remaining portion into a lump. If a diagonal line of a maximum section parallel to the dropping direction of the remaining portion PR is longer than the diameter of the hole H, the remaining portion PR may get stuck in the hole H in the middle of dropping. Thus, sheet boring efficiency of the conventional sheet boring apparatus is low. This phenomenon occurs more easily as a sheet bundle is thicker.

The conventional sheet boring apparatus can been disposed in a main body of an image forming apparatus for forming an image on a sheet, to bore a hole in a bundle of sheets on which images are formed. Thus, an image forming apparatus equipped with a sheet boring apparatus of low sheet boring efficiency has low image forming efficiency.

### SUMMARY OF THE INVENTION

The present invention is directed to a sheet boring apparatus which is configured to bore a hole in a sheet bundle with a laser beam and which facilitates dropping of a remaining portion of the sheet bundle after boring by widening an outer circumferential surface of the remaining portion toward a bottom thereof so as to prevent or reduce remaining of the remaining portion in the hole.

The present invention is also directed to an image forming apparatus of a high operation rate which includes a sheet boring apparatus having an increased sheet boring efficiency by facilitating dropping of a remaining portion left as scrap after a boring process on a sheet bundle.

According to an aspect of the present invention, a sheet boring apparatus configured to bore a hole in a sheet bundle by processing a portion of the sheet bundle along and inside an outline of the hole to form a remaining portion and by dropping the remaining portion is provided. The sheet boring apparatus includes a laser processing unit configured to emit a laser beam on to the sheet bundle to perform boring processing, and a moving portion configured to move an emitting process position of the laser beam. When the laser processing unit performs boring processing, the moving portion moves the emitting process position of the laser beam in a direction of thickness of the sheet bundle and a direction of processing width inside the outline of the hole to narrow the processing width toward a bottom of the sheet bundle.

According to another aspect of the present invention, an image forming apparatus includes an image forming portion configured to form an image on a sheet, and the above-mentioned sheet boring apparatus. The sheet boring apparatus is configured to bundle sheets on which an image or images are formed by the image forming portion into a sheet bundle and to bore a hole in the sheet bundle.

According to an exemplary embodiment of the present invention, when boring a hole in a sheet bundle with a laser beam, a sheet boring apparatus widens an outer circumferential surface of a remaining portion of the sheet bundle left as scrap after the boring process toward a bottom of the sheet bundle. Accordingly, the remaining portion can drop easily without being left in the hole. The sheet boring apparatus can increase sheet boring efficiency.

According to an exemplary embodiment of the present invention, an image forming apparatus includes a sheet boring apparatus having an increased sheet boring efficiency capable of facilitating dropping of the remaining portion left as scrap after the boring process. Thus, an operation rate of the image forming apparatus can be increased.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a sectional diagram of an image forming apparatus as viewed along a sheet conveyance direction according to an exemplary embodiment of the present invention.

FIG. 2 is a perspective diagram of a sheet boring unit according to a first exemplary embodiment of the present invention.

FIG. 3 is a control block diagram of the image forming apparatus illustrated in FIG. 1.

FIG. 4 is a diagram illustrating an operation of the sheet boring unit.

FIGS. 5A to 5C are diagrams illustrating scanning line intervals of laser beams on sheets. FIG. 5A illustrates a case where a scanning line interval is equal to the diameter of a spot of a laser beam. FIG. 5B illustrates a case where a scanning line interval is slightly smaller than the diameter of a spot of a laser beam. FIG. 5C illustrates a case where a scanning line interval is one-half of the diameter of a spot of a laser beam.

FIGS. 6A and 6b are diagrams illustrating operations for boring a hole in a sheet bundle by a sheet boring unit according to a second exemplary embodiment of the present invention. FIG. 6A is a sectional diagram of the sheet boring unit as viewed along a sheet width direction. FIG. 6B is a sectional diagram of the sheet boring unit as viewed from the right side in FIG. 6A.

FIG. 7 is a flowchart illustrating an operation of the sheet boring unit according to the first and second exemplary embodiments of the present invention.

FIG. 8 is a diagram illustrating an operation for boring a hole in a sheet bundle by a conventional sheet boring apparatus.

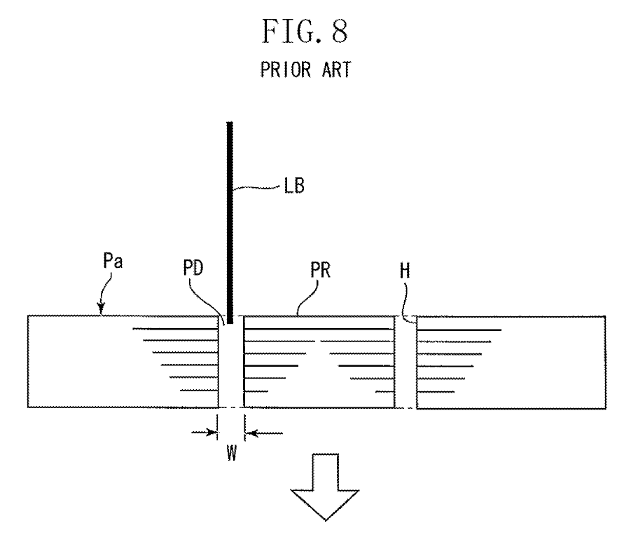

### DETAILED DESCRIPTION OF THE EMBODIMENTS

Various exemplary embodiments, features, and aspects of the invention will be described in detail below with reference to the drawings.

An image forming apparatus and a sheet boring apparatus disposed in a main body of the image forming apparatus will be described according to exemplary embodiments. Numerical values described in exemplary embodiments are exemplary numerical values and in no way limit the scope of the invention.

### First Exemplary Embodiment

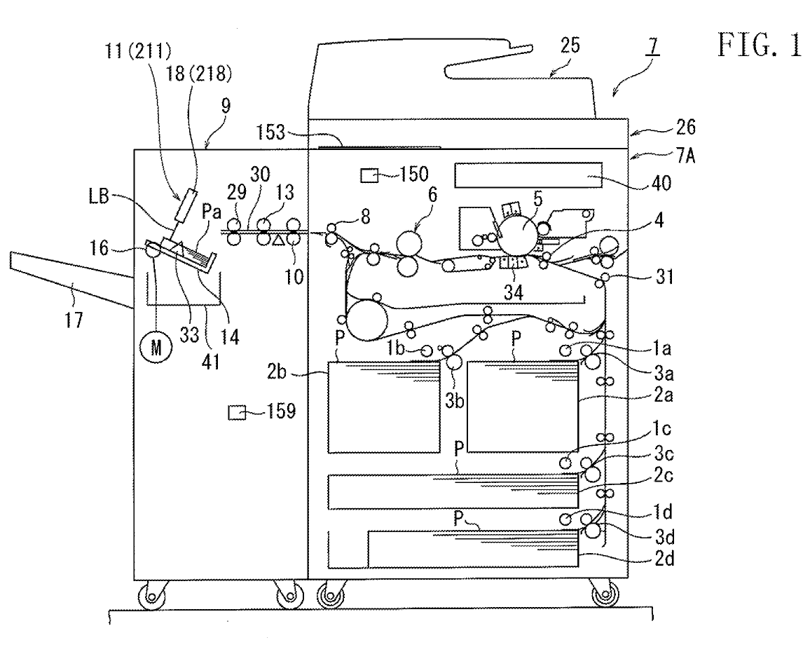

FIG. 1 is a sectional diagram of an image forming apparatus as viewed along a sheet conveyance direction according to an exemplary embodiment of the present invention. The image forming apparatus can be a copying machine, a printer, a facsimile machine, and a multifunction peripheral equipped with such functions.

An image forming apparatus 7 includes an automatic document feeder 25 and an image reading device 26 on a main body 7A. The image forming apparatus 7 transports a document from the automatic document feeder 25 to the image reading device 26, reads the document with the image reading device 26, and copies the document with the main body 7A. The automatic document feeder 25 is not always necessary. If the automatic document feeder 25 is not provided, a user can set a document on the image reading device 26 to read the document. The image forming apparatus 7 can form an image on a sheet by receiving an image information signal from the outside. The image forming apparatus 7 can also transmit image information read by the image reading device 26 to the outside.

The image forming apparatus 7 includes a sheet processing apparatus 9 connected to the main body 7A. The sheet processing apparatus 9 processes a sheet having an image formed by the main body 7a. The sheet processing apparatus 9 may optionally be connected to the main body 7A, or incorporated in the main body 7A. The sheet processing apparatus 9 includes a sheet boring unit 11 configured to bore a hole in a sheet or sheet stack.

In the main body 7A of the image forming apparatus 7, sheets P are selected to be delivered from a sheet cassette 2a-2d by a pickup roller 1a-1d, separated by a separation roller pair 3a-3d to be sent one by one to a pre-registration roller pair 31. The pre-registration roller pair 31 feeds the sheet P to a registration roller pair 4. The registration roller pair 4 corrects any skew of the sheet P and feeds the sheet P between a transfer device 34 and a photosensitive drum 5 serving as an image forming portion. A toner image is formed on the photosensitive drum 5. The transfer device 34 transfers the toner image formed on the photosensitive drum 5 to the sheet P.

Subsequently, the sheet P is fed to a fixing roller pair 6. The fixing roller pair 6 applies heat and pressure to the sheet P to permanently fix the toner image. The sheet P is guided from the main body 7A of the image forming apparatus 7 to the sheet processing apparatus 9 by a discharge roller pair 8.

The sheet processing apparatus 9 can bore a hole, such as a round or square hole for filing, in a sheet bundle with the sheet boring unit 11. An entrance roller pair 10 of the sheet processing apparatus 9 guides the sheet P discharged from the main body 7A by the discharge roller pair 8 of the main body 7a into the sheet processing apparatus 9. A conveyance roller pair 13 feeds the sheet P conveyed by the entrance roller pair 10 to the sheet boring unit 11, which is a sheet boring apparatus for boring a hole in the sheet P.

A conveyance roller pair 29, disposed in a path 30, discharges the sheet P to a processing tray 14. A plurality of sheets P is stacked on the processing tray 14 and aligned in the sheets' width direction by an aligning plate 33 to be made into a sheet bundle Pa. Thus, the processing tray 14 serves as an intermediate processing tray.

A bundle discharge roller pair 16 discharges the sheet bundle Pa bored by the sheet boring unit 11 to a stack tray 17. When the sheet bundle Pa is bored, a remaining portion of the sheet bundle Pa left as scrap after the boring process drops through a discharge hole formed in the processing tray 14 to a dust box 41 to be received there. The dust box 41 is disposed below the processing tray 14.

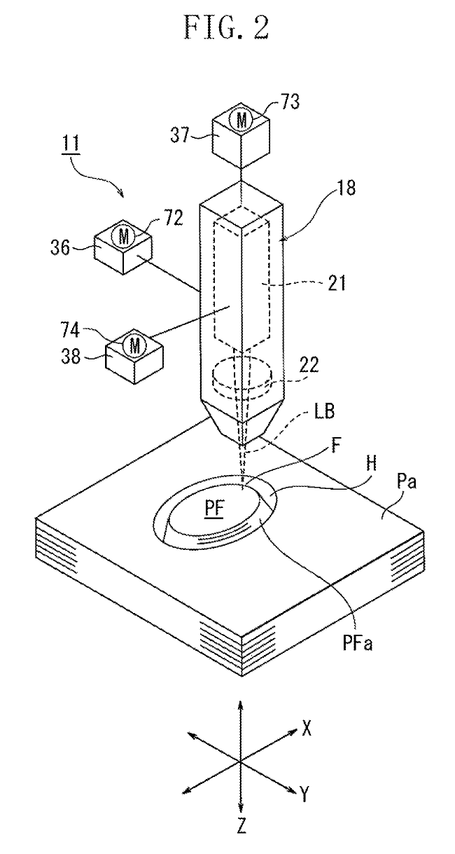

FIG. 2 is a perspective diagram of the sheet boring unit 11 according to a first exemplary embodiment of the present invention.

The sheet boring unit 11 includes a laser emitting device 18 serving as a laser processing unit, a main scanning direction moving device 36 serving as a moving portion, a sub scanning direction moving device 38 serving as a moving portion, and an elevating device 37 serving as a moving portion. The sheet boring unit 11 can bore a hole in a sheet bundle or a thick sheet. The main and sub scanning direction moving devices 36 and 38 serve as a surface direction moving portion. The elevating device 37 serves as a thickness direction moving portion.

An operation of the sheet boring unit 11 will be described with reference to the case of boring a hole in a sheet bundle. However, the sheet boring unit 11 can also bore a hole in a thick sheet. Thus, the sheet bundle includes a thick sheet.

The laser emitting device 18, serving as a laser processing unit, includes a laser emitter 21 having a laser diode (not shown), which flashes according to a light emission signal, and a condenser lens 22 for condensing a laser beam LB emitted from the laser emitter 21 onto the sheet bundle Pa. The output intensity of the laser beam LB is controlled, a range of the sheet bundle Pa to be processed is set in front of and behind an emitting process position (focus) of the laser beam LB, and the focus of the laser beam LB is moved in a three-dimensional direction, thus enabling three-dimensional processing. According to the present exemplary embodiment, the laser emitting device 18 can move in directions X and Y along an upper surface of the sheet bundle Pa, and can move up and down in a direction Z perpendicular to the upper surface of the sheet bundle Pa. In other words, the laser emitting device 18 can move in a three-dimensional direction with the moving portions 36-38. The direction X is a conveyance direction (sub scanning direction) of the sheet bundle Pa. The direction Y is a width direction (main scanning direction) of the sheet bundle Pa. The directions X to Z are orthogonal to one another.

The main scanning direction moving device 36 of the moving portion can move the laser emitting device 18 in the direction Y along the upper surface of the sheet bundle Pa with a main scanning direction moving motor 72 and a gear (not shown). The main scanning direction moving motor 72 includes a stepping motor.

The sub scanning direction moving device 38 of the moving portion can move the laser emitting device 18 in the direction X along the upper surface of the sheet bundle Pa with a sub scanning direction moving motor 74 and a gear (not shown) The sub scanning direction moving motor 74 includes a stepping motor.

The elevating device 37 of the moving portion can move the laser emitting device 18 up and down in the direction Z with an elevating motor 73 and a gear (not shown) to adjust a space between the condenser lens 22 and the sheet bundle Pa, thereby adjusting the position of a focus F of the condenser lens 22 in a direction of thickness of the sheet bundle Pa. The elevating motor 73 includes a stepping motor.

The laser emitting device 18 can be fixed and the processing tray 14 can be moved in the direction X, Y or Z. Alternatively, both the laser emitting device 18 and the processing tray 14 can be moved to change the relative positions in the direction X, Y or Z. Furthermore, the condenser lens 22 alone can be moved up and down while the entire laser emitting device 18 cannot be moved up and down. A focal length of the condenser lens 22 can be changed to enable changing a position of the focus F of the laser beam LB relative to the sheet bundle Pa. In other words, the sheet boring unit 11 can be configured such that at least one of the focus F of the laser beam LB and the sheet bundle Pa can be moved, and the relative positions of the focus F of the laser beam LB and the sheet bundle Pa can be adjusted in a three-dimensional direction.

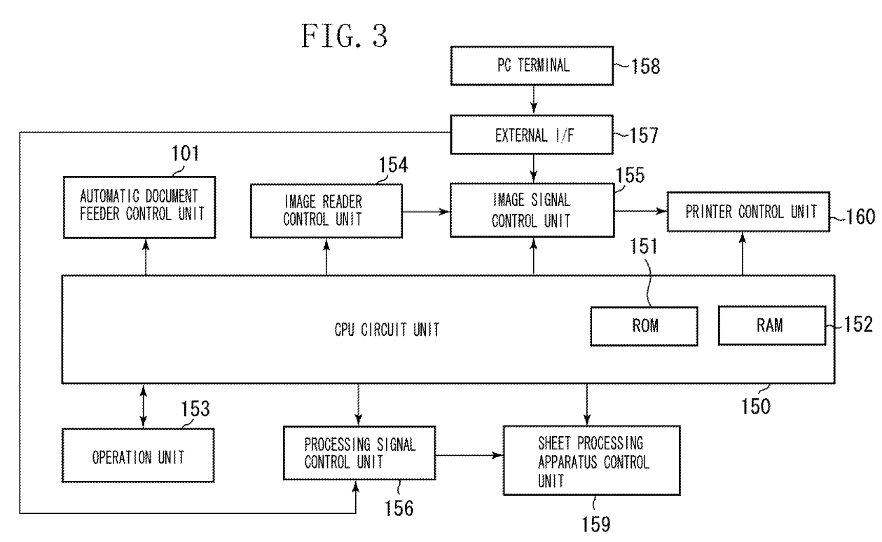

FIG. 3 is a control block diagram of the image forming apparatus 7 illustrated in FIG. 1. A CPU circuit unit 150 includes a central processing unit (CPU) (not shown), a read-only memory (ROM) 151, and a random access memory (RAM) 152, and collectively controls blocks 101, 154, 155, 160, 153, 156, and 159 with a control program stored in the ROM 151. The RAM 152 is used for temporarily holding control data and is used as a work area for an arithmetic operation associated with the control operation.

An automatic document feeder control unit 101 drives and controls the automatic document feeder 25 (FIG. 1) based on an instruction from the CPU circuit unit 150. An image reader control unit 154 drives and controls the image reading device 26 (FIG. 1) to transfer an analog image signal output from the image reading device 26 to an image signal control unit 155.

The image signal control unit 155 executes each processing after conversion of the analog image signal from the image reading device 26 into a digital signal, and converts the digital signal into a video signal to be output to a printer control unit 160. The image signal control unit 155 also executes various processes for a digital image signal input from an external computer (PC terminal) 158 via an external interface (I/F) 157, and converts the digital image signal into a video signal to be output to the printer control unit 160. A processing operation of the image signal control unit 155 is carried out under the control of the CPU circuit unit 150. The printer control unit 160 drives an exposure control unit (not shown) for controlling an exposing device 40 (FIG. 1), which forms a latent image on the photosensitive drum 5 (FIG. 1) based on the input video signal.

An operation unit 153 includes a plurality of keys for setting various functions regarding image formation, and a display unit for displaying information about a setting state. The operation unit 153 outputs a key signal corresponding to each key operation to the CPU circuit unit 150, and displays corresponding information on the display unit based on a signal from the CPU circuit unit 150.

A processing signal control unit 156 executes various processes for a digital signal input from the external computer 158 via the external I/F 157, and converts the digital signal into a control signal to be output to a sheet processing apparatus control unit 159. A processing operation of the processing signal control unit 156 is carried out under the control of the CPU circuit unit 150. The sheet processing apparatus control unit 159 is controlled by the processing signal control unit 156 based on the input control signal.

The sheet processing apparatus control unit 159 is mounted in the sheet processing apparatus 9. The sheet processing apparatus control unit 159 transfers information with the CPU circuit unit 150 to control the sheet processing apparatus 9. One of the sheet processing apparatus control unit 159 and the CPU circuit unit 150 can be incorporated in the other.

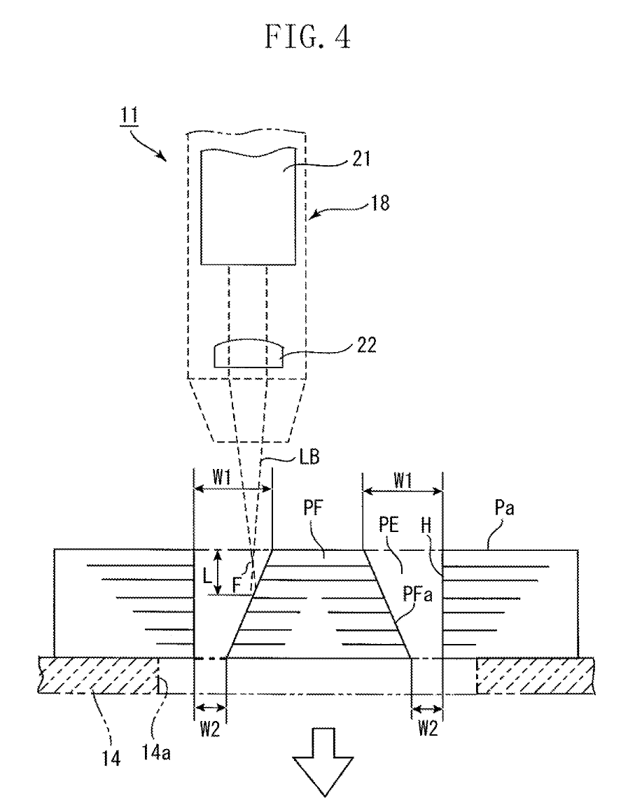

A boring operation of the sheet boring unit 11 will be described now with reference to FIGS. 1 to 4. FIG. 4 illustrates the operation of the sheet boring unit 11.

The sheet processing apparatus control unit 159 controls the sheet boring unit 11 to start an operation for boring a hole in the sheet bundle Pa set on the processing tray 14.

The laser emitter 21 of the laser emitting device 18 applies a laser beam LB to the sheet bundle Pa. The laser emitting device 18 is moved down by the elevating motor 73 of the elevating device 37 to set a position (emitting process position) of the focus F of the laser beam LB within a thickness of the sheet bundle Pa. The laser beam LB processes the sheet bundle Pa within a processing range L. The processing range L indicates a range of the sheet bundle Pa in a thickness direction thereof set in front of and behind the focus F in an advancing direction of the laser beam LB to enable processing of the sheet bundle Pa. Accordingly, the processing range L is longer as an output of the laser beam LB is stronger, and shorter as it is weaker.

Upon setting of the position (emitting process position) of the focus F of the laser beam LB with in the thickness of the sheet bundle Pa, the laser emitting device 18 moves in a two-dimensional direction along an upper surface of the sheet bundle Pa with the main scanning direction moving motor 72 of the main scanning direction moving device 36 and the sub scanning direction moving motor 74 of the sub scanning direction moving device 38. The laser emitting device 18 moves in a two-dimensional direction while applying a laser beam along an inner side of a hole H to be formed in the sheet bundle Pa and processes a portion along the inner side of the hole H by a predetermined width W1. After the processing of the portion along the inner side of the hole H by the predetermined width W1, the laser emitting device 18 causes the position of the focus F to approach the processing tray 14 to change the position of the focus F to a deeper position of the sheet bundle Pa. Then, the laser emitting device 18 moves in a two-dimensional direction to process a portion along the inner side of the hole H by a predetermined width W2. In this case, “W1>W2” is set. Thus, the laser emitting device 18 continues the processing in the thickness direction while narrowing the predetermined width of the portion along the inner side of the hole H to lastly process the portion by the minimum width W2. To shorten processing time, the minimum width W2 is matched with a processing width obtained by one round of laser application. However, after a major part of a remaining portion PF left by a predetermined width from an outline of the hole H to the inner side is dropped, finishing processing can be carried out along the outline of the hole H. The predetermined processing width W1 set on the uppermost surface of the sheet bundle Pa is determined based on the diameter of the hole H to be formed in the sheet bundle Pa and the thickness of the sheet bundle Pa. In other words, the processing width W1 on the uppermost surface of the sheet bundle Pa is set such that a diagonal line of a maximum section parallel to a dropping direction of the remaining portion PF can be shorter than the diameter of the hole H.

Thus, the laser emitting device 18 processes a portion PE along the outline of the hole H to be formed in the sheet bundle Pa into a cylindrical shape with a laser beam and removes the portion PE. In this case, the laser emitting device 18 carries out three-dimensional processing such that a processing width (W) of the portion PE to be processed into a cylindrical shape along the outline of the hole H and to be removed can be smaller toward a bottom of the sheet bundle Pa. Accordingly, an outer circumferential surface PFa of the remaining portion PF left as scrap after the boring process is widened toward the bottom thereof. Thus, the remaining portion PF can drop through a discharge hole 14a (FIG. 4) of the processing tray 14 to be received in the dust box 41 (FIG. 1).

For example, when a hole with a diameter of 5 mm is bored in a bundle Pa of 100 sheets, a laser beam LB is applied such that a processing width W1 of an uppermost sheet set on the processing tray 14 can be set to 1 mm, and a processing width W2 of a lowermost sheet can be set to 0.5 mm. Then, processing widths of the 2nd to 99th sheets between the uppermost and lowermost sheets are gradually changed, or processing widths of every several sheets are changed together stepwise.

With the application of the laser beam LB, a section of the remaining portion PF of the sheet bundle Pa is formed into an approximately trapezoidal shape in which the lowermost sheet is a long side. In the present exemplary embodiment, the hole H to be formed is in a circular shape, and the remaining portion PF after the boring processing is in a truncated cone shape. However, the hole H is not limited to a perfect circle, an oval, or a polygon, but any shape can be employed. Regardless of a shape of the hole H, the outer circumferential surface of the remaining portion PF is widened toward the bottom, and a section of the remaining portion PF is approximately trapezoidal. Thus, the remaining portion PF can smoothly drop. The portion PE processed along the outline of the hole H is removed in a cylindrical shape. However, the shape of the portion PE varies depending on the shape of the hole H. For example, when the hole H is a perfect circle or an oval, the shape of the portion PE is cylindrical. When the hole H is a polygon, the shape of the portion PE is square cylindrical. Shapes of outer and inner circumferences of the cylindrical shape do not have to match each other. The outer circumferential shape can be circular or polygonal, while the inner circumferential shape can be polygonal or circular.

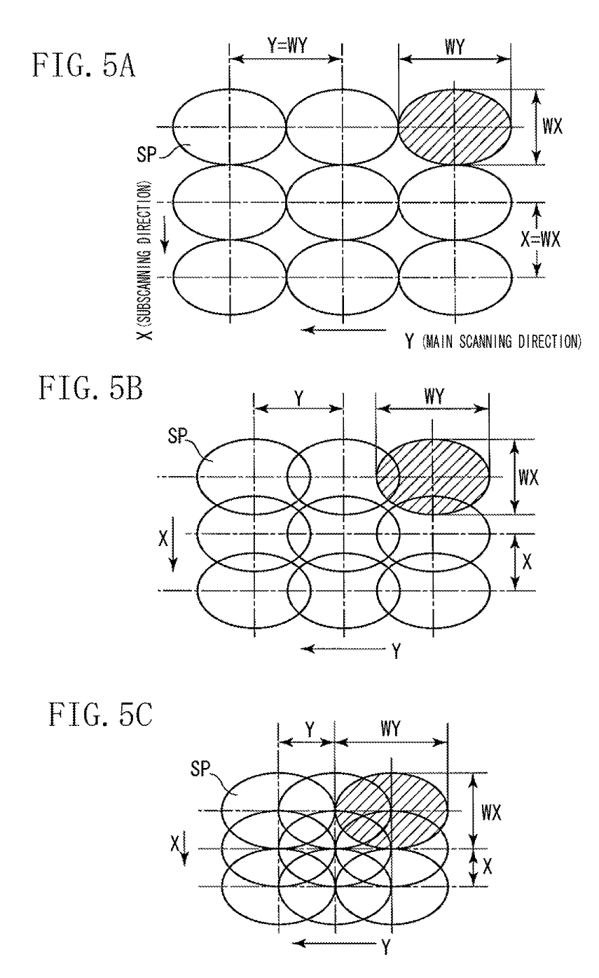

The laser beam is applied as a spot to the sheet. FIGS. 5A to 5C each illustrate spots of a laser beam.

When moving in the sheet width direction (direction Y), the laser beam is applied to the sheet with a width of a minor axis length WX of a spot. When moving in the sheet conveyance direction (direction X), the laser beam is applied to the sheet with a width of a major axis length WY of a spot. Accordingly, an application interval of the laser beam in the sheet width direction is the major axis length WY, and a scanning line interval in the sheet conveyance direction is the minor axis length WX. A portion emitted with the laser beam is processed into a band shape with a width approximately equal to an application width of the laser beam.

Thus, the sheet boring unit 11 can form a circular hole H in the sheet by moving the laser beam in the directions Y and X.

To process and remove a portion along the hole H in a cylindrical shape by applying a laser beam to a sheet, the laser beam can be applied while overlapping spots SP. However, as illustrated in FIG. 5A, the sheet can be processed even when an interval between spots is a maximum. In this case, the interval between spots is expressed by the following equations.

X≦WX (1)

Y≦WY (2)

A portion to be processed can be reliably processed when the spots SP overlap each other. Accordingly, as illustrated in FIG. 5C, adjacent spots (portions to be processed) can overlap each other by approximately one-half of each axis length of the spot. In this case, an interval between spots is expressed by the following equations.

0.5 WX≦X (3)

0.5 WY≦Y (4)

The interval between spots does not have to always satisfy the equations (3) or (4). The interval between spots can be narrower than those of the equations (3) and (4). However, if the interval is too narrow, the number of spots necessary for processing a portion of the same area is increased, thus causing a problem of large power consumption. Also, a problem of longer time for processing the portion arises.

In short, as illustrated in FIG. 5B, overlapping of spots adjacent to each other to a certain extent is useful, and, in this case, an interval between spots is expressed by the following equations.

0.5 WX≦X≦WX (5)

0.5 WY≦Y≦WY (6)

The case where the spot SP is elliptic has been described above. In the case of a spot which is a perfect circle, WX=WY is set, and a similar range can be employed.

Thus, when the laser beam moves in the sheet width direction (direction Y) to process the sheet, the application width WX is a scanning processing width for one round of laser application. However, the sheet is not always processed with the application width WX depending on a type of the sheet or the relative moving speed of the laser beam and the sheet. The scanning processing width for one round of laser application can be smaller or larger than the application width WX.

Accordingly, the scanning line interval in the sheet conveyance direction of the laser beam can be equal to the application width (=minor axis length WX). However, it is useful for the scanning line interval to be a scanning processing width for one round of laser application or an interval with which the scanning processing widths overlap each other.

When moving through application positions while processing the sheet, the laser beam may penetrate the processed portion to irradiate the processing tray 14 supporting the sheet, thus causing damage to the processing tray 14. Thus, loci of the application positions of the sheet should not intersect each other. The intensity of the laser beam is adjusted so as not to damage the processing tray 14, or a member which cannot be damaged is used for the processing tray 14, thus preventing or reducing damage to the processing tray 14.

In the present exemplary embodiment, a spot of a laser beam has an elliptic shape of major and minor axis lengths 90 μm and 60 μm, and a direction of the minor axis length is set as a main scanning direction. Lines adjacent to each other can be overlapped. If this overlapping amount is 30 μm and, for example, a processing width (W) is 3 lines, the processing width is 120(60×3-30×2) μm. Accordingly, the processing width can be changed by changing the number of lines.

### Second Exemplary Embodiment

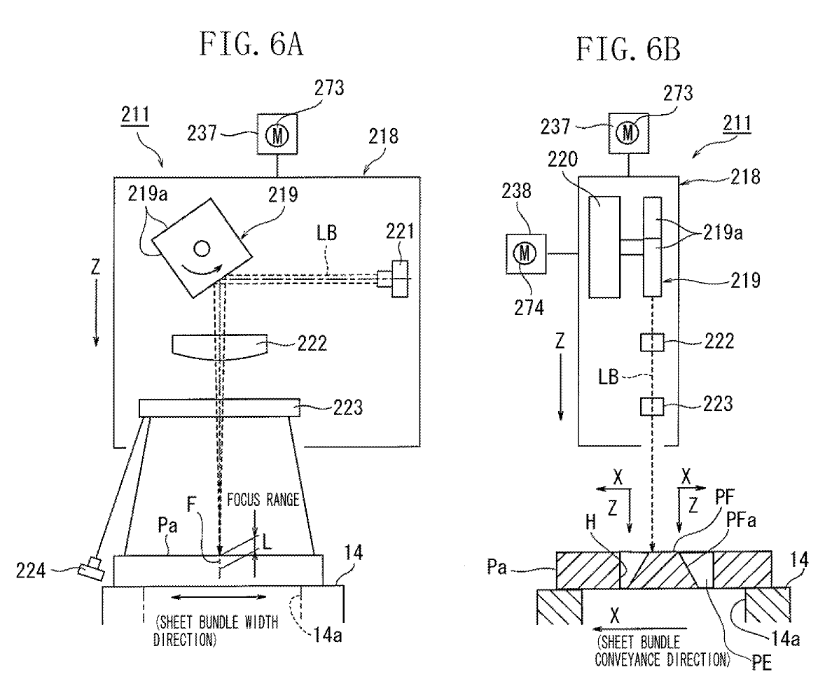

In the first exemplary embodiment, the sheet boring unit 11 moves the entire laser emitting device 18. However, according to a second exemplary embodiment of the present invention illustrated in FIGS. 6A and 6B, a sheet boring unit 211 serving as a sheet boring apparatus moves a laser beam. FIG. 6A is a sectional diagram of the sheet boring unit 211 as viewed along a sheet width direction. FIG. 6B is a sectional diagram of the sheet boring unit 211 as viewed from the right side in FIG. 6A.

The sheet boring unit 211 includes a laser emitting device 218 serving as a laser processing unit, a sub scanning direction moving device 238 serving as a moving portion, and an elevating device 237 serving as a moving portion. The sheet boring unit 211 can bore a hole in a sheet bundle or a thick sheet with a laser beam. The sub scanning direction moving device 238 serves also as a surface direction moving portion. The elevating device 237 serves also as a thickness direction moving portion.

An operation of the sheet boring unit 211 according to the present exemplary embodiment will be described now with reference to the case of boring a hole in a sheet bundle. However, a hole can similarly be bored in a thick sheet.

A laser emitting device 218 includes a laser emitter 221, a polygonal mirror 219 serving as a surface direction moving portion, a polygonal mirror driving motor 220, and condenser lenses 222 and 223.

The laser emitter 221 emits a laser beam with a laser diode (not shown), which flashes according to a light emission signal. The polygonal mirror 219 includes four mirrors 219a (not limited to four) for reflecting a laser beam LB emitted from the laser emitter 221, and is formed into a square shape in section. The polygonal mirror driving motor 220 rotates the polygonal mirror 219.

The sub scanning direction moving device 238 moves the laser emitting device 218 in a direction X along an upper surface of a sheet bundle Pa with a sub scanning direction moving motor 274 and a gear (not shown). The sub scanning direction moving motor 274 includes a stepping motor.

The elevating device 237 moves the laser emitting device 218 up and down in a direction Z with an elevating motor 273 and a gear (not shown) to adjust a space between the condenser lens 222 and the sheet bundle Pa, thus adjusting a position of a focus F of the condenser lens 222 in a direction of thickness of the sheet bundle Pa. The elevating motor 273 includes a stepping motor.

The laser emitting device 218 can be fixed and a processing tray 14 can be moved in the direction X or Z. Alternatively, both the laser emitting device 218 and the processing tray 14 can be moved in the direction X or Z to be relatively moved in the direction X or Z. Furthermore, the condenser lens 222 alone can be moved up and down without moving the laser emitting device 218. In other words, the sheet boring unit 211 can be configured such that at least one of the focus F of the laser beam LB and the sheet bundle Pa is moved, and the relative position of the focus F of the laser beam LB and the sheet bundle Pa can be adjusted in the directions X and Z.

A boring operation of the sheet boring unit 211 will be described below.

The laser emitter 221 emits a laser beam LB to the polygonal mirror 219. The polygonal mirror 219 rotates in a direction of an arrow shown in FIG. 6A. The laser beam LB is reflected as a polarized beam whose angle is changed by the mirror 219a.

The laser beam LB reflected from the mirror 219a of the polygonal mirror 219 is detected by a beam detection (BD) sensor 224 before scanning in a width direction of the sheet bundle Pa. A BD signal output from the BD sensor 224 is used as a scanning start reference signal for scanning in the width direction of the sheet bundle Pa. With the BD signal used as a reference, a laser application start position in the width direction of the sheet bundle Pa can be synchronized.

The reflected light from the mirror 219a of the polygonal mirror 219 is subjected to correction of distortion by the condenser lenses 222 and 223, and scans a surface of the sheet bundle Pa set on the processing tray 14 in the width direction of the sheet bundle Pa intersecting a sheet conveyance direction to emit to the sheet bundle Pa. The laser emitting device 218 is moved down by the elevating motor 273 of the elevating device 237 to set a focus F of the laser beam LB within a thickness of the sheet bundle Pa.

Upon setting of the focus F of the laser beam LB within the thickness of the sheet bundle Pa, the laser beam LB moves in the sheet width direction and the sub scanning direction moving motor 274 of the sub scanning direction moving device 238 starts operating. Accordingly, the laser beam LB moves while processing a portion of the sheet bundle Pa along the inner side of a hole H by a predetermined width.

The laser emitter 221 does not always emit a laser beam. The laser emitter 221 emits a laser beam only when a portion of the predetermined width along the inner side of the hole H is scanned.

After the processing for the predetermined width along the inner side of the hole H, the laser emitting device 218 causes the focus F of the laser beam LB to approach the processing tray 14. The laser emission device 218 then processes a portion of the sheet bundle Pa along the inner side of the hole H by a processing width smaller than the previous processing width. Thus, the laser emitting device 218 continues the processing in the thickness direction while narrowing the predetermined width of the portion along the inner side of the hole H to lastly process the portion by the minimum width.

Thus, the laser emitting device 218 processes a portion PE along the outline of the hole H to be formed in the sheet bundle Pa into a cylindrical shape with a laser beam and removes the portion PE. In this case, the laser emitting device 218 carries out three-dimensional processing such that a processing width (W) of the portion PE to be processed into a cylindrical shape along the outline of the hole H and to be removed can be smaller toward a bottom of the sheet bundle Pa. Accordingly, an outer circumferential surface PFa of the remaining portion PF left as scrap after the boring process is widened toward the bottom thereof. Thus, the remaining portion PF can drop through the discharge hole 14a (FIG. 4) of the processing tray 14 to be received in the dust box 41 (FIG. 1).

As in the first exemplary embodiment, the sheet boring unit 211 according to the second exemplary embodiment can bore a hole in the sheet bundle Pa while overlapping spots SP of the laser beam LB.

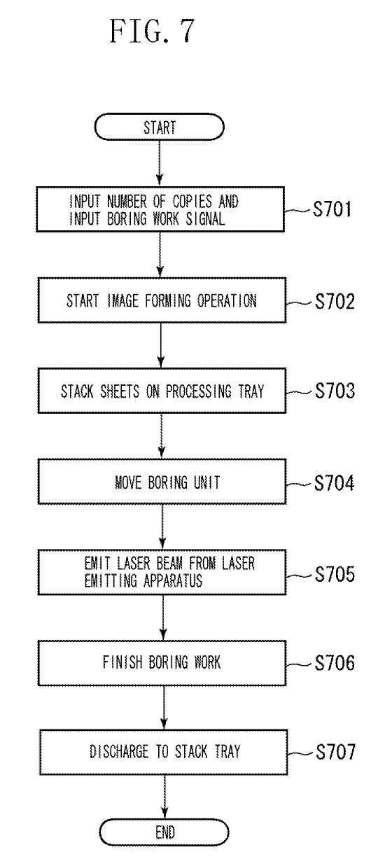

Operations of the sheet boring units 11 and 211 will be described now with reference to FIG. 7.

With the image forming apparatus 7 (FIG. 7), a user inputs the number of copies to the operation unit 153 and inputs a work signal for bundling sheets into a sheet bundle and boring a hole in the sheet bundle (step S701). The image forming apparatus 7 starts an operation for forming an image or images on the input number of sheets (step S702). The image forming apparatus 7 forms an image or images on the sheets in the main body 7A and feeds the sheets to the sheet processing apparatus 9. The sheet processing apparatus 9 receives the input number of sheets and stacks the sheets on the processing tray 14 (step S703).

The sheet processing apparatus control unit 159 controls the sheet boring unit 11 (211) to start an operation for boring a hole in the sheet bundle set on the processing tray 14 (step S704). The laser emitter 21 (221) of the laser emitting device 18 (218) applies a laser beam LB to the sheet bundle (step S705). The sheet boring unit 11 (211) moves at least one of the focus F of the laser beam LB and the sheet bundle Pa to adjust the relative position of the focus F and the sheet bundle Pa in a three-dimensional direction, and then bores a hole in the sheet bundle Pa (step S706). The bored sheet bundle Pa is discharged to the stack tray 17 (step S707).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2006-205815 filed Jul. 28, 2006, which is hereby incorporated by reference herein in its entirety.

What is claimed is:

1. A sheet boring apparatus configured to bore a hole in a sheet bundle by processing a portion of the sheet bundle along and inside an outline of the hole to form a remaining portion and by dropping the remaining portion, the sheet boring apparatus comprising:
a laser processing unit configured to emit a laser beam onto the sheet bundle to perform boring processing; and
a moving portion configured to move an emitting process position of the laser beam,
wherein, when the laser processing unit performs boring processing, the moving portion moves the emitting process position of the laser beam in a direction of thickness of the sheet bundle and a direction of processing width inside the outline of the hole to narrow the processing width toward a bottom of the sheet bundle.

2. The sheet boring apparatus according to claim 1, wherein the moving portion includes a surface direction moving portion configured to move at least one of the laser processing unit and the sheet bundle along an upper surface of the sheet bundle, and a thickness direction moving portion configured to move the laser processing unit in the direction of thickness of the sheet bundle to move the emitting process position of the laser beam.

3. The sheet boring apparatus according to claim 1, wherein the laser processing unit scans along an upper surface of the sheet bundle with the laser beam.

4. The sheet boring apparatus according to claim 1, wherein the moving portion moves at least one of the laser processing unit and the sheet bundle along an upper surface of the sheet bundle, and
wherein the laser processing unit changes the emitting process position of the laser beam in the direction of thickness of the sheet bundle.

5. The sheet boring apparatus according to claim 1, wherein the laser processing unit flashes on and off the laser beam according to a light emission signal, and emits the laser beam when processing the processing width.

6. The boring apparatus according to claim 1, wherein the processing width inside the outline of the hole on an uppermost surface of the sheet bundle subjected to the boring processing is determined based on a diameter of the hole and a thickness of the sheet bundle.

7. An image forming apparatus comprising:
an image forming portion configured to form an image on a sheet; and
the sheet boring apparatus according to claim 1,
wherein the sheet boring apparatus is configured to bundle sheets on which an image or images are formed by the image forming portion into a sheet bundle and to bore a hole in the sheet bundle.
